(19) United States
(12) Patent Application Publication
(10) Pub. No.: US 2011/0178947 A1
(43) Pub. Date: Jul. 21, 2011

(54) GREETER METHODS AND SYSTEMS

(76) Inventors: Reginald Leslie McNutt, Plymouth, MN (US); Richard Miller Stark, Long Lake, MN (US); Brian Lee Schroeder, Maple Grove, MN (US)

(21) Appl. No.: 12/689,734

(22) Filed: Jan. 19, 2010

(51) Int. Cl. G06Q 50/00; A47F 10/06; A47F 10/02; G06Q 99/00; G06Q 10/00; G06F 17/00; G06F 15/16

(52) U.S. Cl. 705/346; 186/53; 700/94; 709/219

(57) ABSTRACT

A restaurant greeter method includes storing a plurality of greeting messages in memory of a greeter, associating at least one greeting message with a specific time of day, playing the at least one greeting message from the memory of the greeter upon detection of an individual at the specific time of day, and playing a different message if an individual is detected and the time is not at the specific time of day. Messages and other data can be downloaded from a remote server or loaded at the greeter. The greeter can be interrupted by a base station. Each of the messages can be temporally assigned. In an example, a bypass circuit selectively connects the greeter intermediate to the menu post and the base station.

### FIELD

This application relates generally to greeters, and, more specifically, to electronic greeters that provide messages, e.g., audio messages, to potential consumers at commercial locations and retail locations, including drive through retailers and other person interaction locations.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Greeters have been used to record messages at the retail store and play those messages when a play command is issued. Greeters have not found major success in drive through restaurants or convenience stores.

### BRIEF DESCRIPTION OF DRAWINGS

Example embodiments are illustrated by way of example and not limitation in the figures of the accompanying drawings, in which like references indicate similar elements and in which:

FIG. 1 is a block diagram showing a greeter system, in accordance with an example embodiment;

FIG. 2 is a block diagram showing a greeter system, in accordance with an example embodiment;

FIG. 3 is a diagrammatic representation of an example machine for a greeter, in the form of an electronic system within which a set of instructions for causing the machine to perform any one or more of the methodologies discussed herein are executed, in accordance with an example embodiment;

FIG. 4 is a block diagram showing a greeter, in accordance with an example embodiment;

FIG. 5 is wiring diagram for a greeter system, in accordance with an example embodiment;

FIG. 6 is a block diagram illustrating a greeter system, in accordance with an example embodiment;

FIG. 7 is a flow diagram illustrating greeter logic, in accordance with an example embodiment;

FIG. 8 is a flow diagram illustrating greeter installation, in accordance with an example embodiment;

FIG. 9 is a flow diagram illustrating greeter programming, in accordance with an example embodiment;

FIG. 10 is a diagrammatic representation of an interface to control a greeter, in accordance with an example embodiment;

FIG. 11 is a diagrammatic representation of an interface to control a greeter, in accordance with an example embodiment; and

FIG. 12 is a diagrammatic representation of device to create messages and playlists, in accordance with an example embodiment.

### DETAILED DESCRIPTION

In an example embodiment, a greeter is installed in a retail system, e.g., a drive through retailer, a drive through restaurant, a bank, pharmacy, or other location where an individual is greeted at a location, to play messages to a potential or actual consumer. The greeter can be remotely loaded with messages from a central server. The greeter can further be loaded with playlists that are only enabled at a specific time. In an example, the greeter includes a play module that enables certain playlists at certain times of day and/or certain days of the week. In a further example, the greeter is remotely loaded from a location remote from the sales location.

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

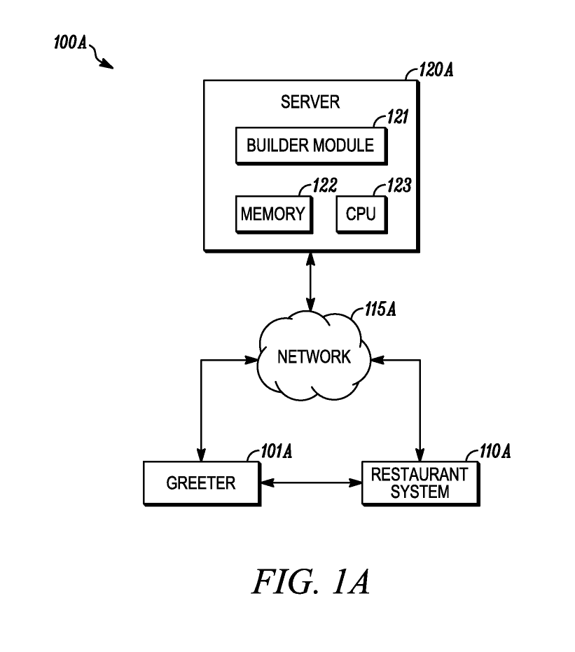

FIGS. 1A and 1B illustrate example environments 100A and 100B, within which a greeter 101A or 101B can be implemented. As shown in FIG. 1A, the example environment 100A comprises a retail system 110A that communicates over a network 115A to a server 120A. The retail system 110A can include a remote ordering system, such as drive through restaurant, warehouse store, drive through convenience store, etc.

The network 115A is preferably a global computer network, such as the Internet, but can be any network capable of communicating data between devices can be used with the present system. In addition to the Internet, suitable networks can also include or interface with any one or more of, for instance, an local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications can also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 115A can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 115A can further include satellite communications.

The server 120A can be a computer system at a remote location from the retail or commercial system 110A. The server 120A can receive sales information from the retail system 110A through the network 115A. The sales information can be end of the day sales information to allow remote accounting and ordering of inventory. The server 120A can further set pricing information at the retail system 110A. The server 120A can further electronically communicate with banking or credit card processing companies to process electronic transactions on behalf of the retail system 110A. Server 120A can connect to recording studios, message databases, schedule building modules, playlist building modules, etc.

The greeter 101A can also electronically, magnetically, or optically communicate with the server 120A, which can be located at remote location of a company that schedules the greeter or provides data to the greeter. The greeter 101A can also provide data back to the server 120A to confirm receipt of data from the server. The greeter 101A can further provide detailed data regarding the messages, music, or playlists that were played by the greeter to the server.

As shown in FIG. 1B, the example environment 100B comprises a business system 110C that communicates over a network 115C to a server 120C. The network 115C can be the same type of network as described above with regard to network 115A. The server 120C can be a dedicated server, with memory and a processor for executing instructions on data, wherein the data and instructions can be stored in the memory. The business system 110C can include a remote ordering system, such as drive through restaurant, warehouse store, drive through convenience store, etc. or other customer interaction location, here show as location 130. The business system 110C communicates with the greeter 101B and can communicate through the greeter 101B to the interaction location 130. The greeter 101B communicates to a server 120B through a network 115B. The network 115B can be the same type of network as described above with regard to network 115A. While shown as separate networks 115B, 115C, it will be recognized as within the scope of the present disclosure that the networks 115B, 115C can be the same network that provides different communication links. The server 120B is separate and distinct from the business server 120C. Server 120B can include a builder module 121, a memory 122, and a processor 123. The builder module 121 can operate to create data, e.g., content, for the greeter 101B. The server 120B can provide data to the greeter 101B through the network 115B and does not need to communicate with the business server 120C or the system 110C.

The greeter 101B can be set up to pull data from the server 120B. In an example, a code is entered into greeter 101B, which in turn sends a request for updated in formation along with an identification code for the specific greeter. Stated another way, the greeter 101B is set up to contact the server at regular intervals. The server 120B checks its memory for stored updates that have not been downloaded to the greeter 101B. If the server 120B finds that there is an update stored in memory 122 (which update can be created by the builder module 121), then the servers sends the update to the greeter 101B over the network 115B. A confirmation signal can be exchanged between the greeter 110B and server 120B to confirm that the update is received.

The greeter 101B can also be set up as a passive device to which updates can be pushed to the greeter by the server 120B. The server 120B can create updated data and send it to the appropriate greeter for which the data was created. The greeter 101B receives and stored the data from the server 120B. The servers 120A or 120B in communication with the greeter are adapted to program a content file that assigns different output, audio message(s) to be played by a greeter at different times of a day and at a different days of the week. For example, different messages can be played during morning (e.g., breakfast) hours, afternoon (e.g., lunch) hours, evening (dinner) hours, and/or late night hours. The server can further create content file that includes a schedule based on the day of the week to include daily specials. The server can further create content file that includes a message schedule based on a promotional time period, e.g., based on an advertising run, a product tie-in, a national special, etc. The server can further create schedules based on national promotions as well as local promotions.

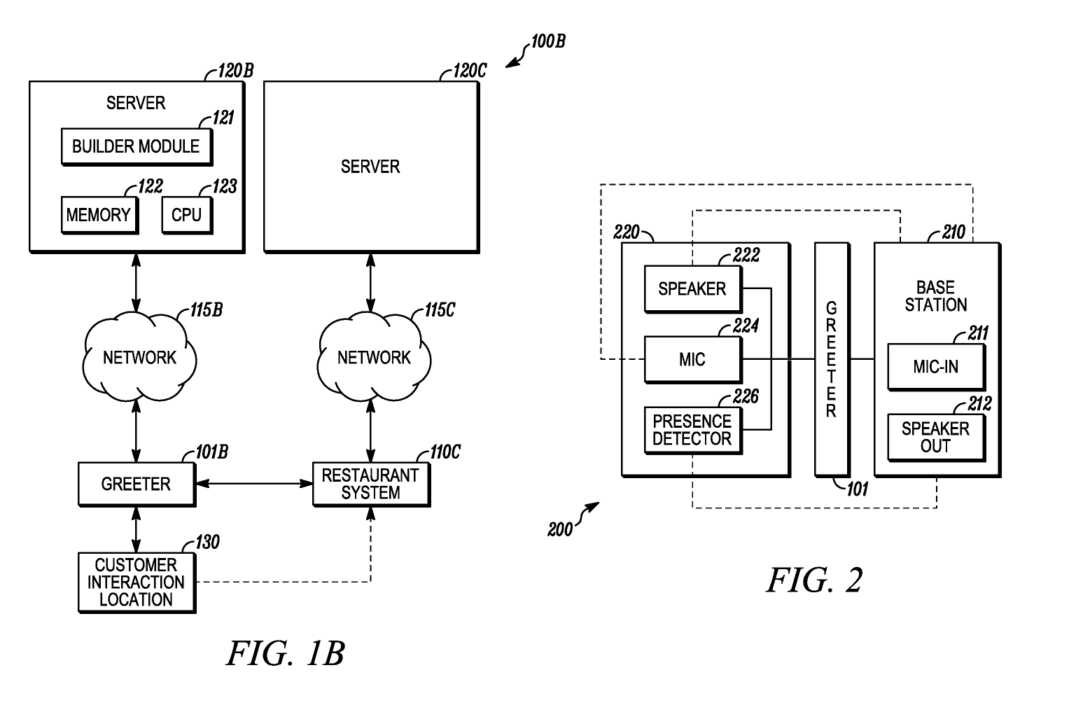

FIG. 2 shows a communication system 200 that interacts between a retailer and an individual (e.g., a consumer). System 200 includes a base station 212 that is connected to a human interaction device 220 through a greeter 101. The base station 212 can include an input port or microphone 211 and an output or speaker 212. The human interaction device 220 can include a speaker 222, a microphone 224, and a presence detector 226. The presence detector 226 can automatically determine whether an individual is at the device 220, which can be an order pedestal at a drive through restaurants, an ATM, etc. In an example, the presence detector 226 includes a manually activatable switch or button that a person can activate to indicate their presence. In an example, the presence detector 226 detects presence of an automobile or other vehicle. Such a presence detector can detect a large metal object. The presence detector 226 can produce a dry contact closure signal that can be used to trigger the message play in a greeter and indicate to a business that a customer is present at the device 220. The dry contact closure signal can be a voltage or other signal that the greeter can use to indicate the presence detection to the base station 210. In an example, the signal can be passed through the greeter to the base station right away, so that the individual at the base station can hear the message too, or the output detection to the base station can be delayed until the message has finished playing. In an example, the presence detector is voice activated and once an individual speaks into the speaker 222, the presence detector 226 detects the presence of the individual. In an example, the presence detector 226 is a light beam interruption system. Once a presence is detected, the greeter 101 automatically plays a greeting message or messages. A person at the base station 211 can speak to an individual at the device 220 through the microphone which will be played through the speaker 222. The person at the base station 210 can hear an individual at the device 220 that is speaking into the microphone 224 through the speaker 212. In an example, the greeter 101 is scheduled to play a message through the speaker 222 at the human interaction device 220 until the base station 212 begins to communicate to the device 222 at which time the greeter 101 halts the message. In an example, the greeter 101 plays the entire message and then allows communication between the device 226 and the base station 210.

As described herein the greeter 101 in some examples can be bypassed so that the base station 210 and the person interaction device 220 can communicate directly to each other without interaction by the greeter 101. These communication lines are shown in broken line in FIG. 2. In another example, the greeter 101 provides a communication line between the base station and interaction device 220 but cannot interrupt the communications there between.

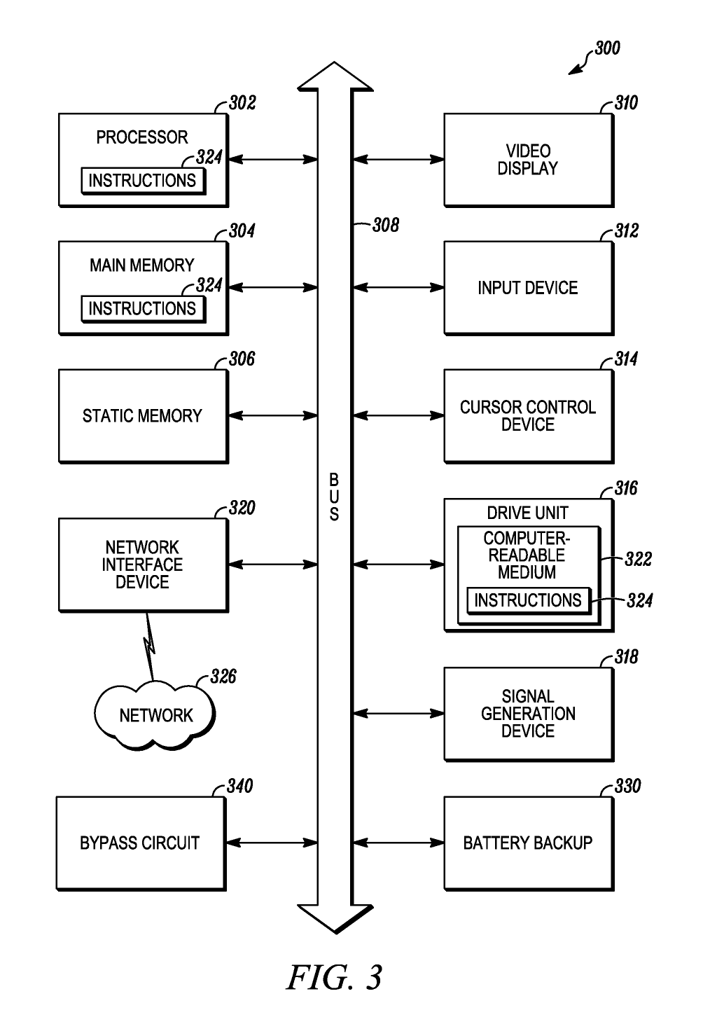

FIG. 3 shows a diagrammatic representation of a computing device for a machine to be used as a greeter in the example electronic form of a computer system 300, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can include structures that are used in a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player, a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor or multiple processors 302 (e.g., a central processing unit (CPU), a graphics processing unit (GPU), or both), and a main memory 304 and a non-volatile memory 306, which communicate with each other via a bus 308. The computer system 300 can further include a video display unit 310 (e.g., a liquid crystal display (LCD), plasma, light emitting diode or a cathode ray tube (CRT)). The computer system 300 may also includes input devices 312 (e.g., multiple use push buttons located on the outside of a housing, a keyboard as an alphanumeric device, electronic inputs for remote control systems, electronic inputs for signal communication with other devices), a cursor control device 314 (e.g., a mouse or directional buttons), a disk drive unit 316, a signal generation device 318 (e.g., a speaker) and a network interface device 320. The display unit 310 can display the volume level of the device, the mode of operation of the device, e.g., local control mode or auto mode. Display unit 310 can also display the name of the message currently being played or recorded. The display unit can further remind a user that an update of messages is due.

The drive unit 316 includes a computer-readable medium 322 on which is stored one or more sets of instructions and data structures (e.g., instructions 324) embodying or utilized by any one or more of the methodologies or functions described herein. The instructions 324 can also reside, completely or at least partially, within the main memory 304 and/or within the processors 302 during execution thereof by the computer system 300. The main memory 304 and the processors 302 also constitute machine-readable media. Drive unit 316 can be a magnetic or optical storage media such as a magnetic disk drive or a CD/DVD drive. Drive unit 316 can further be a solid state drive unit that includes non-volatile memory, such as flash, NOR, NAND or other memory. The drive unit can further be a portable solid state drive that is connectable via a USB connection to the bus 308.

The instructions 324 can further be transmitted or received over a network 326 via the network interface device 320 utilizing any one of a number of well-known transfer protocols (e.g., Hyper Text Transfer Protocol (HTTP), CAN, Serial, Modbus).

While the computer-readable medium 322 is shown in an example embodiment to be a single medium, the phrase “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application and/or data (e.g., audio messages and scheduling content) on which the instructions can be executed, or that is capable of storing, encoding, or carrying data structures utilized by or associated with such a set of instructions. The phrase “computer-readable medium” shall accordingly be taken to include, but not be limited to, solid-state memories, optical and magnetic media, and carrier wave signals. Such media can also include, without limitation, hard disks, floppy disks, flash memory cards, digital video disks, random access memory (RAMs), read only memory (ROMs), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

The main memory 304, static memory 306, and/or drive unit 316 can store audio or video data to be used as messages by the greeter. These storage devices can also store schedules that link any messages or playlists to a time period, date, or date range when a specific message can be played by the greeter. In an example, the messages are digital data. These storage devices can store up one hundred separate messages and can store an additional eight to ten locally recorded messages. It will be recognized that additional messages can be stored with the addition of memory capacity and addressing The storage devices can further store the internet protocol (IP) address of the device as well as the IP address of the server from which the greeter can communicate. In an example, the greeter is limited to specific addresses to which it can communicate for increased security.

The example computer system 300 includes a battery backup 330 that can power the system 300 in the event of power interruption. The battery backup 330 can be charged when normal power form the power grid is supplied to the system 300. When power is interrupted to the system 300, the battery backup 330 can power the system 300 to either orderly shutdown the system or provide power to the greeter system 300 to play a message that indicates to an individual that the system to which the greeter is connected system 300 is connected is down due to a power failure.

The above refers to computer system 300 as a structure for the greeter 101. It will be understood that the server 120 and/or business system 110 can include any or all of the features described with regard to system 300.

The example computer system 300 includes a bypass circuit 340 that allows other devices to communicate with each other directly when in normal operation the system 300 as a whole provides the communication link. In an example, the bypass circuit 340 can be removable from the remainder of the system 300 so that the remainder of the system can be removed from other devices at the retail location. In an example, the bypass circuit 340 can provide a communication link between a speaker, sensors, and a base station (not shown in FIG. 3) when the remainder of the system 300 is removed, turned off, or powered down.

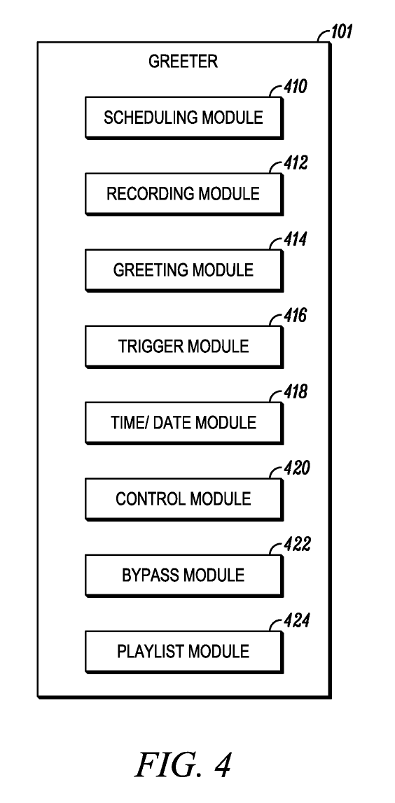

FIG. 4 shows a diagrammatic representation of a greeter 101 that includes modules 410-424. The modules can include memory, processors, buffers, data and/or instructions stored on a tangible media to perform methods described herein. A scheduling module 410 is to schedule messages, greetings or playlists in the greeter 101. It can also reduce output volume based on time of day, for municipalities that require reduced outdoors volume during night hours. The recording module 412 is to allow a person physically located at the greeter 101 to record a message that the greeter can play. Accordingly, the greeter 101 can play greetings downloaded from remote location, downloaded from a portable memory device and greetings recorded locally at the greeter. The greeting module 414 operates to oversee and track all of the greetings stored in the greeter. A greeting module 414 stores the greetings, i.e., messages. A trigger module 416 operates to begin a message played by the greeter. In an example, the presence of an individual is detected by the trigger module and an instruction is sent to play the scheduled greeting message. The trigger module can further set a delay time before the message is triggered for play after the presence of a customer is detected. The default setting is to wait one second after detection before a message is played. This delay can be adjusted at the greeter to decrease or increase the delay. A time/date module 418 is to track the date and time for use in the greeter to play the appropriate or scheduled message and/or enable the correct play list. A control module 420 operates to oversee the operation of all other modules and resolve resource conflicts and control communication with other devices. A bypass module 422 operates to allow the other devices in a system to communicate with each other and bypass the other modules in the greeter 101. A playlist module 424 organizes playlists of messages. The playlist module 424 can receive playlists from a remote server, manually from a pc on the network, or from other connected storage media. In an example, the playlist module 424 can organize the playlists as directed by a person physically at the greeter through I/O devices as described herein.

In operation, the control module 420 receives the time and date from the module 418 and requests the appropriate playlist from playlist module for the current time and day. Based playlist, the listed messages are downloaded from the greeting module 414 and held in a buffer, or are played directly from memory in the greeting module. Once, the trigger module receives a trigger signal that a message should be played, the control module 420 chooses the designated message, or it chooses a message from a designated play list based on either random or linear order, and then plays the message from memory or loaded in the buffer. The trigger module 416 can further provide a random schedule were the messages in the greeting module are randomly played.

In some embodiments, the greeter can play up to 24 different playlists during a day. In one example, up to eight different playlists can be played.

Each greeter 101 can include an identification code that uniquely identifies the greeter. Thus, the server 120 can download messages and/or schedules unique to any specific greeter or a group of greeters. In an example, a plurality of greeters forms a group that all receive the same content. This group of greeters can receive messages, data, schedules, etc from the server 120A or 120B through the network 115A or 115B.

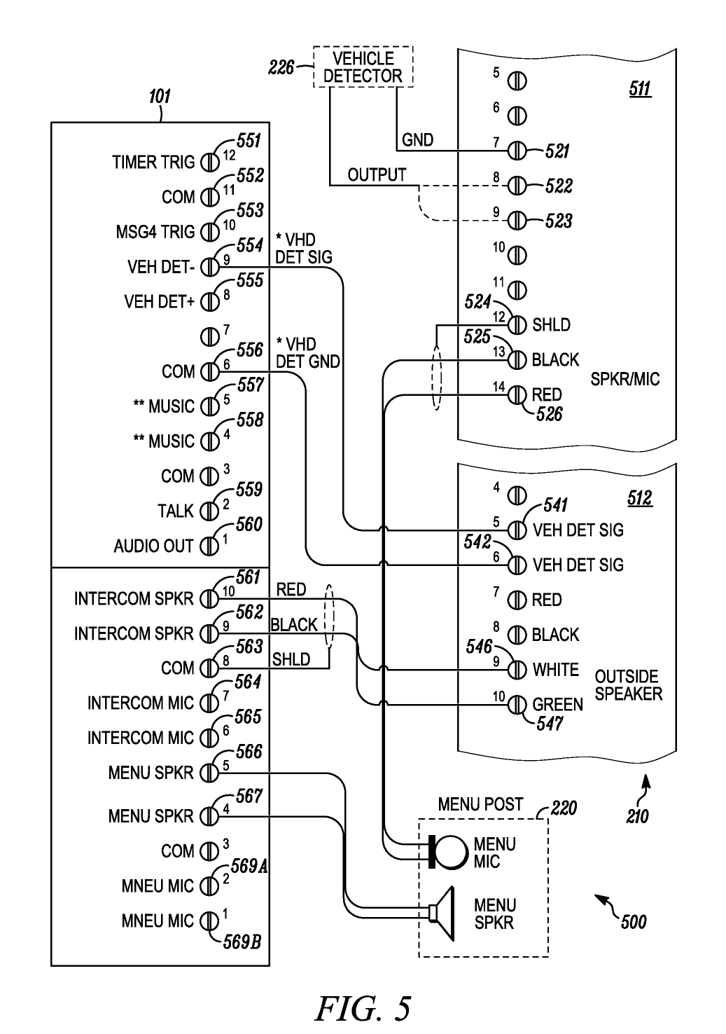

FIG. 5 shows a diagrammatic representation of a greeter 101 that is connected to a customer interaction system 500. System 500 can include a presence (for example, a vehicle detector) 226 connected to a base station assembly 210. A person interaction device 220 is provided and connected to both the greeter 101 and the base station assembly 210. The person interaction device 220 is to provide communication channels to and from a person. In an example, the person interaction device 220 can be a menu post. The base station assembly 210, greeter 101, person interaction device 220, which can include detector 226, each can have electrical connections to provide signals between the respective devices. It will be recognized that other presence detectors 226 can be used and may be separate from the interaction device 220. The base station 210 is divided into a first part 511 that connects to the detector 226 and person interaction device 220 and a second part 512 that connects to the greeter 101. In an example, the presence detector only connects to the base station through the greeter. The ground connection from the detector 226 is connected to terminal 521. The positive or output connection from detector 226 is connected to terminals 522-523. Other terminals need not be used and can provide additional functionality for the base station 210. Terminals 524, 525, 526 are the shield, negative and output terminals connected to the microphone terminals at the person interaction device 220 so that the person at device 220 can remotely communicate with a person at the base station 210. The base station 210 can include a wireless communication system that can talk to a headset of a person representing the company. In an example, the base station 210 can communicate over a global communication network to a person remote from the base station, who represents the company. The base station's second part 512 includes terminals 541, 542 that connect to terminals 554 and 556 of the greeter to signal to the greeter that the detector 226 has sent a presence detected signal to the base station, which in turn sends a detected signal to the greeter 101. Upon receipt of the presence detected signal in the greeter (for example, at the trigger module 416 of the FIG. 4 embodiment), the greeter 101 plays a select message, which can be from a playlist or on a schedule based on the location of greeter 101 and/or time of day and/or day of week and/or day of year. The message schedule can be set by the scheduling module 410 in the FIG. 4 embodiment. Other modules of the FIG. 4 embodiment can be used as required. Terminals 546, 547 are outside speaker terminals that are connected to speaker of the device 220 through terminals 561, 562 and 566, 567 of the greeter.

The greeter 101 can include further terminals 551-553, 555, 557-560, 563-569B that can connect the greeter 101 to other electrical devices. Terminal 551 can connect to the timer module or timer trigger circuit within the greeter with a timer trigger source (not shown in FIG. 5) that can supply a timer trigger signal. Terminals 552, 556, and 563 provide communication to external devices. Terminal 553 is a specific message trigger input that can be connected to an external trigger device that can launch a specific message to be played. In an example, the external trigger device can be a power out signal device, a restaurant closed signal generator, an emergency message trigger device, etc. Once this signal is received a dedicated message will be played overriding other scheduled messages. Terminal 555 provides a further, typically opposite polarity to terminal 554 for a vehicle detect signal from a base station 210. Thus, if the base station 210 outputs either a negative vehicle detected signal or a positive vehicle detected signal, the greeter 101 can be connected to the base station without additional circuits. In an example, this greeter can accept either a dry contact closure or a voltage signal from presence detector. The shown connections are for a signal that is a voltage out. In an example, the terminal 555 can be a connection to an internal supply voltage through a current limiting resistor. If the vehicle detect was a dry contact closure, you would connect terminal 555 would output a vehicle detect signal based on another input. Terminals 557, 558 provide connects to a music source so that the greeter can play music. In an example, the music source (not shown in FIG. 5) is a balanced source and could be used to provide music when there is no message to be played by the greeter or to fill long lulls in communication from the person at the base station to the individual at the interaction device 220. In an example, the music is played when the person at the base station provides a hold signal to the greeter. This can be done via an electrical signal from the base station to the greeter. Modules in the greeter can output the signal music from terminals 557, 558 to the speaker output terminals 566, 567 to the device 220 speaker. Terminal 559 can provide an input for a microphone or other voice signal. In an example, terminal 559 can be input a signal from base station to abort the playing of a message. Terminal 560 can provide an audio output terminal that can output audio messages to further device that can further process the messages to deliver the same to the device 220. Terminal 560 can be used for internal monitoring inside store where the base station is located, e.g., so a person can hear what message is being played, other than listening through the headset, which is listening in on the microphone at the menu post). Terminals 564, 565 can provide for a microphone input to replace the microphone input of the base station. Accordingly, greeter 101 can provide a backup to the base station for interpersonal communication between staff in the business and the individual at the interaction device 220. The terminals described herein provide electrical connections, input and/or output, to electrical circuits, e.g., modules, within the respective device.

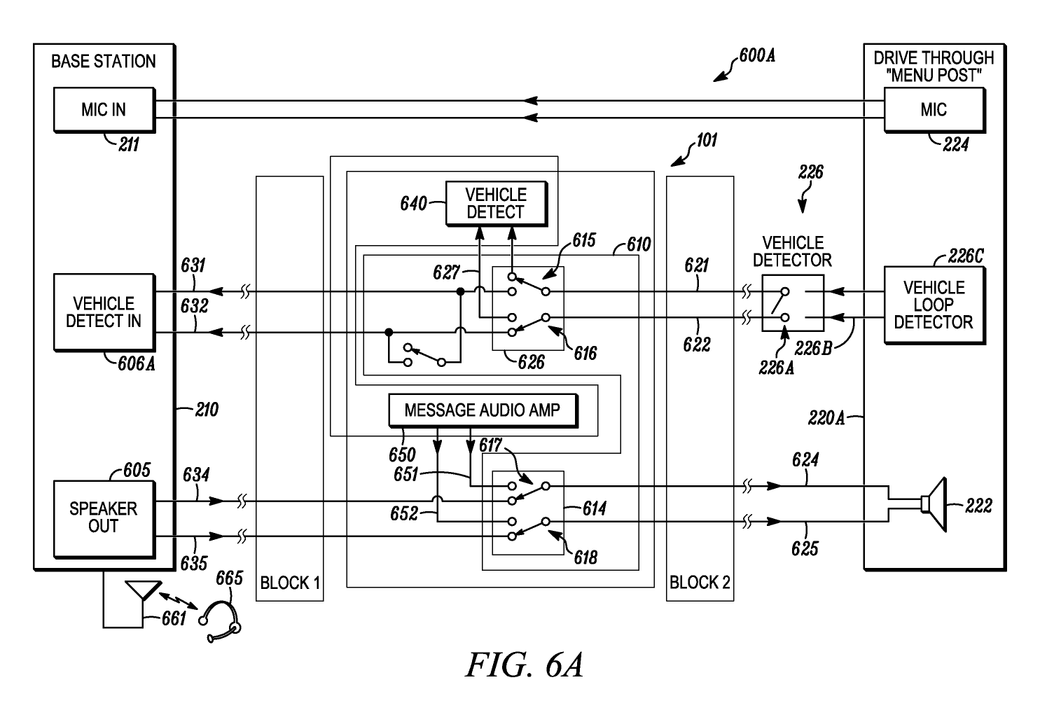

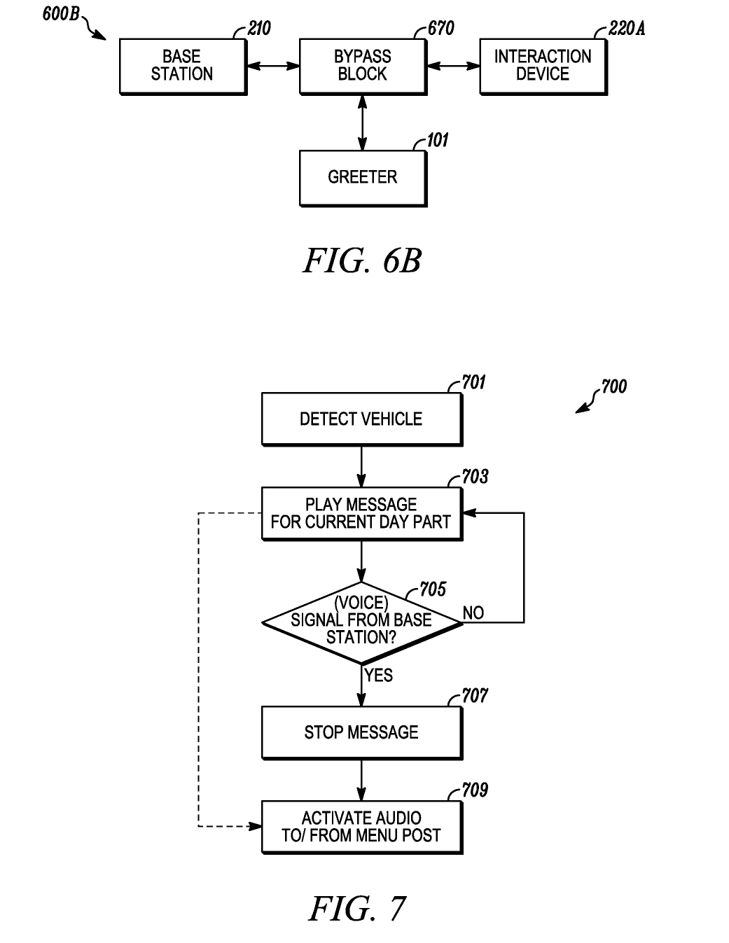

FIG. 6A shows a diagrammatic representation of a system 600 that includes a greeter 101 with a bypass module 610, a base station 210, and a drive-through, individual interaction device as a menu post 220A. The bypass module 610 can selectively bypass the greeter 101 so that the menu post 220A and the base station 210 can connect and communicate directly to each other bypassing the greeter 101.

A menu post 220A provides similar features as an interaction device 220 described herein with the difference that a menu of products (or services) for sale are listed. The prices could also be listed. The menu post 220 can also include an electronic message device that can provide visual images of advertisements, sales, promotions, list of ordered items, sale totals and/or individual costs of ordered items. The menu post can be positioned outside in the weather so its components must withstand the elements over time.

The base station 210 includes direct wiring between its microphone input module 211 and the microphone 224 of the menu post 220A. A vehicle detect module 226A and a speaker output module 605 are connected to the menu post 220A through the greeter 101 and bypass module 610. The vehicle detect module receives a signal from the vehicle loop detector 226C that a large metal object is in the vicinity of the loop detector at the menu post 220A. This signal is read at the detector and it closes its relay 226A to generate a presence signal. The vehicle detector 226 can also operate on an optical basis to sense presence of a vehicle. This signal is fed to the bypass module 610.

The bypass module 610 provides a selective bypass for the base station 210 to communicate directly to the menu post 220A in the event that the greeter 101 is removed from the system 600, or if it is turned off or powered down. Bypass module 610 can include two relays 612, 614. A further relay can be provided on the microphone 224 to microphone in 211, if needed. The relay 612 includes a first switch 615 that connects line 621 of the vehicle detector 226 to line 626 of the module 610 that in turn connects to a vehicle detect terminal of the vehicle detect module 640 of greeter 101. If the greeter is not plugged into the bypass block, switch 615 connects line 621 to line 631 that connects to the vehicle detect 606A of the base station. Second switch 616 of relay 612 connects line 622 of the vehicle detector 226 to line 627 of the module 610 that in turn connects to a vehicle detect terminal of vehicle detect module 640 of the greeter 101. If the greeter is not plugged into the bypass module, switch 616 connects line 622 to line 632 that connects to the vehicle detect 606 of the base station.

The vehicle detect module 640 of the greeter 101 can include a relay that selectively shorts or opens the lines 631, 632 depending on the short or open status of the switch 226A in the vehicle detector 226. The vehicle detect module 640 repeats the same signal that the vehicle detect 226 outputs. The greeter 101 can further use the vehicle detect signal received through relay 612 to trigger a message or playlist. In an example, a trigger module receives the vehicle detect signal and starts a greeting to be played at the relay 614 to the speaker 222.

Relay switch 614 are as shown in the position where the greeter 101 is installed and is ready to monitor the vehicle detect signal. Here, the speaker-out lines 634, 635 are connected directly by the switches 617, 618 to the speaker in lines 624, 625 of the speaker 222 through relays 614, 615. With the greeter 101 in place and a message ready to play, the relay 614 will move switches 617, 618 so that a message module 650, e.g., lines 651, 652, is connected to the speaker input lines 624, 625.

FIG. 6B shows a diagrammatic representation of a system 600 that includes a greeter 101, a base station 210, and a drive-through, individual interaction device as an interaction device (e.g., menu post) 220A, and a bypass block 670. The bypass block 670 can selectively bypass the greeter 101 so that the interaction device (e.g., menu post) 220A and the base station 210 can connect and communicate directly to each other bypassing the greeter 101 with the greeter physically removed from the connection to the bypass block 670. In an example, the bypass bock 670 is an RJ31X block. Patch cords can connect the greeter 101 to the bypass block 670 and with the cords plugged into the bypass block, the electrical connections are changed to include connections to the greeter and open the direct connections between the base station and interaction device.

Base station 210 includes a wireless broadcaster, e.g., an RF signal transmitter, receiver, or generator, a band pass filter, and an antenna 661 that wirelessly communicate with a headphone/microphone assembly 665. Base station 210 includes a wireless broadcaster, e.g., an RF signal transmitter, receiver, or generator, a band pass filter, and an antenna 661 that wirelessly communicate with a headphone/microphone assembly 665.

Referring back to FIG. 1, the server 120 can include a builder module 121, a memory 122, and a processor 123 that can each communicate with each other to perform the tasks required to provide messages, playlists, schedules, and other instructions to the greeter 101. The builder module 121 can be software instructions operating on hardware (e.g., the processor 123) to record a message. The builder 121 can further designate the specific greeter or groups of greeters to which any specific message can be downloaded. Builder module 121 is to create playlists and schedules for any individual greeter by day parting or other time parting. That is, any time of day, day of week, time of year, etc. can be assigned a specific message to be played at the greeter by the builder module. Builder 121 can further assign messages to only play at specific times of day or specific days of the week or both. Builder 121 can further assign a play until date to each message. That is, a message for Christmas may only play until December 25 and then the message can be not be played. The greeter that has this Christmas message will only load the message for play after it has checked the play until date. If that data has past, then the greeter will not play the message. The builder module 121 can further create playlists for specific greeters or groups of greeters. The playlists can be day based so that each day of the week only those messages on the play lists can be played the greeter with playlist. The builder module 121 can further build a playlist for each hour of the day and for each day of the week. Schedules for a week, month, or any multiple day time period can also be constructed by the builder. The message, playlists, schedules and data base of greeters can be stored in memory 122, which can be magnetic storage, optical storage, or solid state memories.

In another example, the server 120 receives a data file from a separate builder program that is executed by a processor interacting with memory on a separate computing device, which can include many of the same structures as shown in FIG. 3 except for the bypass circuit. The builder program can be a builder module on a different computing system. The builder software creates a single content data file that contains audio messages, playlists, and schedules. Control and security data can also be part of the single content file. The content file(s) from the builder program is uploaded to the server 120, where the files are assigned to a group of one or more greeters to receive the file and, hence, the exact same content. This content is then assigned a date when it becomes active in a greeter. More than one content file can be assigned to a group and scheduled as desired. When the greeter 101 connects with the server 120, it identifies itself. The server checks if a new or updated content file is available, and if so, sends it to the greeter. Alternatively, the content files produced by the builder program can be pushed into the greeter 101 by a user accessing the greeter 101 from the network using a computer on the network. Access can be through internal web pages (and addresses) built into the greeter 101. Alternatively, the content file from the builder program can be placed on a portable memory device, e.g., USB flash drive, compact disk, DVD, etc., which can be inserted into and read by the greeter 101.

FIG. 7 is a flow diagram illustrating a greeting method 700, in accordance with an example embodiment, for a drive through restaurant. At 701, a vehicle is detected at an order site. That is, a vehicle has pulled up to the drive through menu post. At 703, a greeter receives the signal that a vehicle is detected and automatically plays the message (electronically stored in the greeter) for the current day part or according to a script in a content file stored locally in the greeter. During playing of the message, a further detection of a voice signal from the base station is performed at 705. Alternatively, a base station may output a message stop signal that can command the greeter to stop the message play and connect the base station and menu post for electronic communication, i.e., audio, data, video, etc. This will indicate that the employee is ready to take the customer's order. If no signal is received at 705, the message continues to play. If the message completes, then a further message can be played. The further message is also stored locally in the greeter and is selected according to a day part or according to a script in the content file. The content files are created remotely at a server, e.g., server 120A or 120B. If a voice signal is detected, then the message is stopped at 707. At 709, the communication to and from the menu post is activated.

FIG. 7 shows a further embodiment with the change being shown in broken line 710. The greeter message for the current day part is played at 703. After the message completes the process moves to the activate communication between the base station and the menu post at 709.

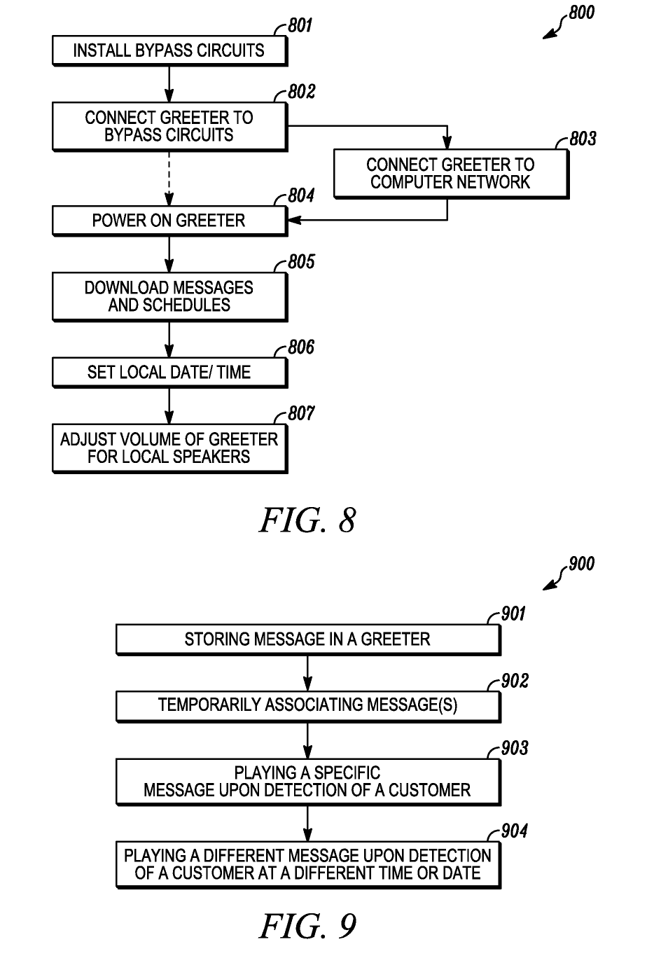

FIG. 8 is a flow diagram illustrating a greeting installation method 800, in accordance with an example embodiment. At 801, the bypass block is installed at the business, e.g., a drive-through restaurant, between the base station and the customer interaction device, e.g., a menu post. At 802, the greeter is connected to the bypass circuits such that the greeter can communicate with both the base station and the customer interaction device. At 803, the greeter is connected to a computer network such that control instructions and messages can be downloaded to the greeter from a remote location over the computer network. In an alternate method, the step 803 is skipped and the method moves from step 802 to 804. However in this method messages and schedules must be loaded using portable memory devices or scheduled at the greeter. At 804, the greeter is powered on. The greeter loads its bios settings and instructions from its memory. At 806, the current and local date and time is set or confirmed if the greeter has prior date and time loaded. In an example, a local person must input the local date and time using manual input devices on the greeter. In another example, the computer connection is used to request the date and time, e.g., from server 120 or from a reliable time and date source in a router or other server, etc. At 807, the volume of the greeter is adjusted of the local speakers. The greeter system provides volume control as the performance of speakers varies by the type of speaker used at the customer interaction device.

In the step 805, the greeter with an IP address can be accessed using a web browser loaded onto a computing device that is internet compatible. Accordingly, the local user can create local messages and load them into the greeter using a standard web browser.

FIG. 9 is a flow diagram illustrating a method 900 for using a greeter, in accordance with an example embodiment. At 901, a plurality of greeting messages is stored in memory of a greeter. These messages can be recorded at the greeter or loaded into the greeter over a communication network or loaded into the greeter from a portable memory device, for example, a flash memory drive, CD-ROM, DVD disk, etc. Loading the messages can be performed by service at the server or by a local user using a web browser. At 902, the messages are associated with specific times of the day or days of week or other temporal periods. In one example, a drive through restaurant divides a day into four periods, closed, breakfast, lunch, and dinner. Specific messages are dedicated to at least one of these times. For example, the closed message that informs a customer that the drive through is closed and provides the open operation hours is only associated with the restaurant-closed time period. A message offering a breakfast special are only associated with the breakfast time period, e.g., six a.m. to eleven a.m. A message regarding a lunch special are only associated with a lunch time period, e.g., eleven a.m. to two p.m. A message regarding dinner options or specials are associated with a dinner period, e.g., two p.m. to midnight. The association step can occur in the greeter or a schedule builder module that can be located remote from the greeter, e.g., in the server 120 shown in FIG. 1. If the association is done remotely, then the association of the message with a specific time is also loaded to the greeter and stored therein, e.g., in step 901 described above or in a separate loading step.

At 903 and 904 the messages are played from the greeter to a person, e.g., a person at a service window for a business, such as a drive through window, a walk-up window, etc. At 903, the greeter selects a specific message based on the time and/or date or from a playlist based on time and/or date, and plays that message based on the time and date. In an example, more than one message can be played for that time and date. In one example, a company-wide or national message can be played, and then a location or restaurant specific message can be played. The national message can be a product tie-in announcement for example promotion for a new movie or launch of a new toy line. The local message can follow. Once the time of day moves into a different time or date period such that the message played in step 903 is not in that time period, a different message is played upon detection of a customer at 904.

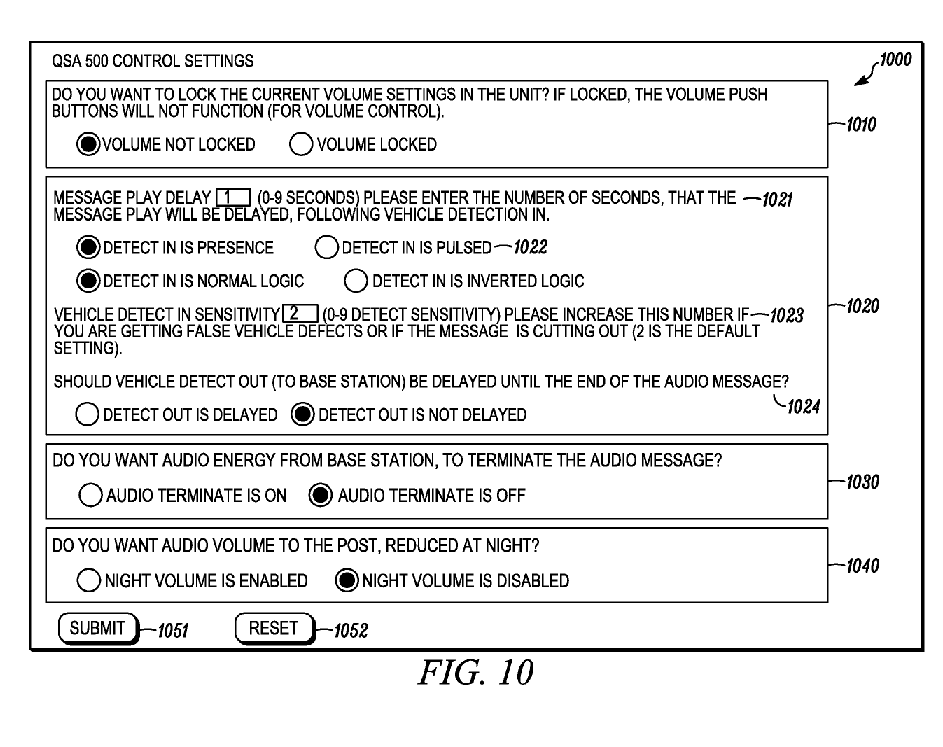

FIG. 10 shows a control page 1000 that can be displayed on a display device of a computer. The control page can be on the greeter or can be a computer display on a local area network that is attached greeter. In a further example, the control page 1000 is displayed at the server 120 (FIG. 1). The control page 1000 includes a plurality of input windows to enter control settings for the greeter. A volume control input window 1010 can include a volume lock input to lock the current volume setting to prevent a change of the volume at the greeter. In a further example, the volume control input window 1010 can include a volume control input as well set the volume. A message trigger window 1020 includes a message play delay input 1021 to set the amount of delay after presence is detected. Vehicle detect settings inputs 1022 are provided and can include whether the detect-in signal is a presence signal or a pulsed signal and whether the detect-in signal is normal logic or inverted signal. Vehicle detect sensitivity input 1023 includes a signal sensitivity to reduce false vehicle detect signals Vehicle detect delay output 1024 provides a control to delay the vehicle detect signal in the greeter prior to passing it to the base station. A greeter message termination window 1030 provides an input to allow audio energy from the base station to terminate the message being played by the greeter. A night time volume reduction window 1040 is provided to allow the volume setting to be reduced at night. This allows the message to be played at night at a reduced volume as a courtesy to people who live or work near the interface device, such as a menu post. A save settings input button 1051 is provided that will save the settings input in the control page 1000 to the greeter. A reset button 1052 is provided that will reset the settings on the control settings page to either the prior settings or the default factory settings.

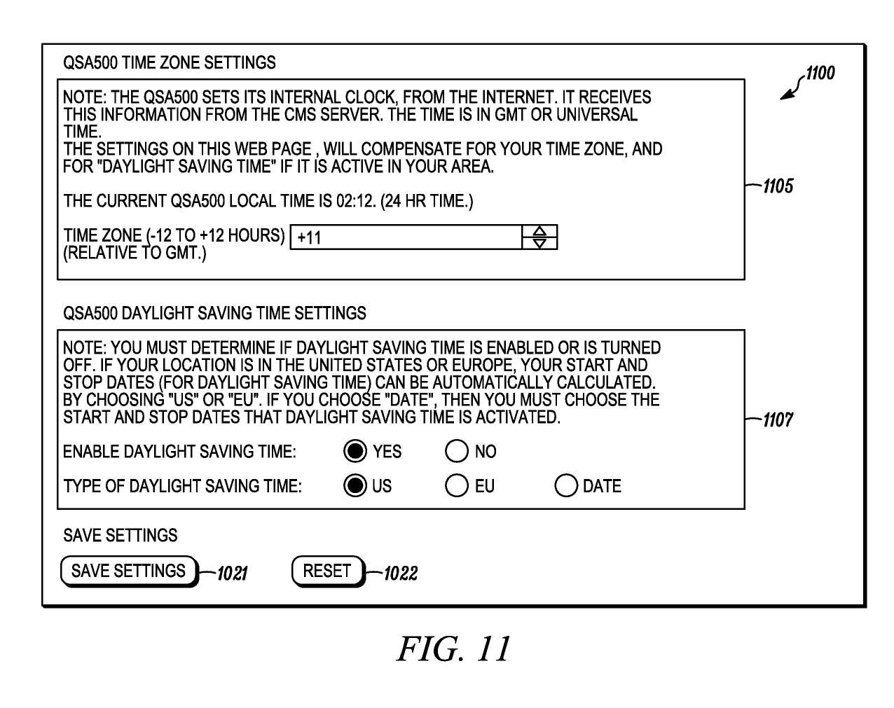

FIG. 11 shows a time control page 1100 that can be displayed on a display device of a computer. The time control page 1100 can be on the greeter or can be a computer display on a local area network that is attached greeter. In a further example, the time control page 1100 is displayed at the server 120 (FIG. 1). The time control page 1100 includes a plurality of input windows to enter time settings for the greeter. A time zone settings window 1105 provides an input to set the local time for the greeter. This can be relative to the GMT or universal time. In a further example, the local time can be typed into an input box and the greeter can convert the local time to a GMT or universal time. A daylight savings time window 1107 is provided that inputs a setting of whether the local of the greeter uses daylight savings time and the type of daylight savings, e.g., the USA or the EU or a date driven daylight savings that is different than the USA or EU.

Other control pages can be provided to input data such as control settings or messages or schedules. Examples of other pages can include network settings page that allows a user to input the greeter IP address into the page or set the DHCP and to input the gateway IP address, network netmask, DNS IP address, or other communication addresses. The page can also set an address, such a uniform resource locator or other, to the server 120 that can input data to the greeter.

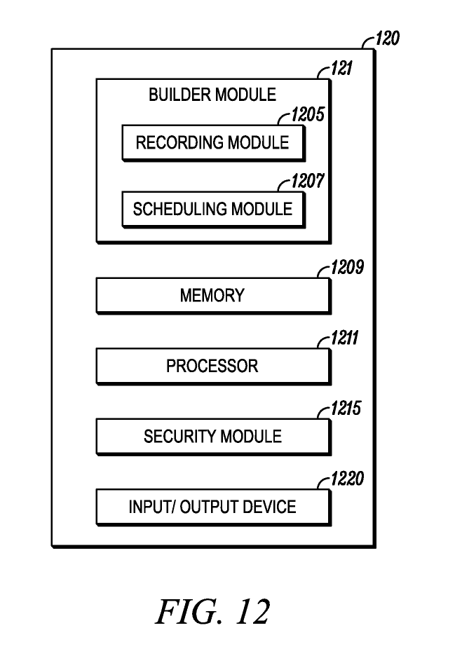

FIG. 12 shows the server 120 as a messaging scheduling device that is remote from the greeter. Server 120 includes a builder module 120 that includes a recording module 1205 and a scheduling module 1207. Modules as used herein can include hardware executing instructions that can be hardwired or loaded from software to provide certain specific functionality. The recording module 1205 creates messages that will be stored in memory 1209. The messages can be dedicated to certain businesses or part of advertising campaigns. The messages can promote certain select products or be merely informational messages. In some cases, the messages can be loaded into memory 1209 from a source outside the server 120. The scheduling module 1207 assigns the recorded messages stored in memory 1209 to a part or certain time of day at which the message can be played. The scheduling module can further assign messages to have an expiration date after which a greeter cannot play the message. Scheduling module 1207 can further indicate that some messages that are in the same time period or day part can be played randomly. In other cases, the scheduling module 1207 assigns messages to be played in a specific order in their assigned time period or day part. The scheduling module can also day part an entire day's worth of messages that will be played by a greeter. The scheduling module can further schedule messages and store the message (and schedule itself) in a content file and assign the content file to one or more greeters. The scheduling module 1207 can further act to assign any properties or features to a content file or message as described herein. A security module 1215 can password protect or encrypt content files such that only a greeter to which the content file is assigned can open, access, or play the content file. The security module can further require identification codes from a greeter attempting to access the greeter 120. The server 120 can be a standalone server that can communicate with all greeters, individually or in groups of greeters via an input/output device 1220. The I/O device 1220 can be adapted to communicate using electronic networks, e.g., network 115.

While many of the descriptions above refer to the messages as audio, it will be recognized that video can be included in the content files and in the messages.

The present inventors recognized the failure of others to provide an adequate solution to the problems in the greeter market. In particular, the present inventors unexpectedly recognized that automated greeters were not adequately used in the drive through markets, where evidence exists that use of suggestion of products to consumers increases sales. Moreover, such suggestions are typically spoken by employees at a drive through location. Sales opportunities may be lost due to failure of the employee to state the proper messages each time, failure to activate the microphone at the proper time, wait time of a customer if the employee is busy with other tasks, failure of the employee to speak properly for voice reproduction at the menu post, among others. These are all significant problems that reduce sales opportunities. A greeter as described herein solves many of these problems. The messages played by the greeter can be managed more consistently across a store or a franchise or a brand. The messages can be professionally voiced at a remote server and loaded to the greeter over a network. Further, certain voices can be selected for certain locations to match local tastes. For example, a Boston accent can be used to record a message for stores in the New England area, while a Texas accent can be used to record a message for greeter in the Texas stores. Schedules or playlists can further be built at a remote server and loaded to the greeter over the network.

The present inventors further recognized the need to provide a remote computing device with appropriate programming to create the content files for a greeter. At some locations where a greeter can be used, the management does not have the time or resources to adequately train personnel to properly program a complex messaging schedule into a greeter. Accordingly, the present inventors unexpectedly discovered that more complex greeters, while providing improved sales opportunities, encounter some resistance to their adoption in the marketplace. The present inventors solved this problem by providing a centralized device to create the content files for the greeters.

The greeter can further allow for some deviation and control by the local manager or employee at the greeter location. Controls can be provided on the greeter to override certain schedules, playlists or messages.

The greeter can further schedule or apply a schedule to play messages at certain times of day or days of week. This allows a custom message to be played when appropriate. For example, a message suggesting a breakfast special is only played while the drive through restaurant is serving breakfast. A message suggesting a super-sized lunch is played only at lunch time. A message that the restaurant drive through is closed can be played when the restaurant is closed.

Accordingly, the greeter is customizable to different platforms, stores, franchises (who may or may not be participating in a promotion), and industries. Moreover, customization can be done remotely at a central location.

In summary, the greeter is a messaging unit that can play a specified message consistently each time to inform customers of current promotions and specialty items while removing some reliability and consistency problems that exist in current real-time spoken messages. The messages used in the greeter can be updated remotely over private or public computer networks. The potential benefits of the greeter are increased sales and bottom line profits, professional up-selling to each customer, reduction in store manager involvement, reduces training for staff in up-selling techniques, messages can promote higher margin products, among others. This can all be done with a proven return on investment for installing a greeter.

The above description uses alphabetic suffixes at times and at other times refers to elements without the suffix. It will be understood that each of these can be the same element and the numerical reference character, with or without suffix, refer to the same or similar element.

Thus, structures and methods for greeters have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

1. A restaurant greeter method comprising:
storing a plurality of greeting messages, which are created remotely from the greeter, in memory of a greeter;
associating at least one greeting message with a specific time of day;
playing the at least one greeting message from the memory of the greeter upon detection of an individual at the specific time of day; and
playing a different message if an individual is detected and the time is not at the specific time of day.

2. The method of claim 1, wherein playing the at least one greeting message includes detecting a vehicle at a menu in a drive-through restaurant.

3. The method of claim 2, wherein playing the at least one greeting message includes interrupting the greeting message upon detection of an audio signal between the menu post and a base station.

4. The method of claim 1, wherein playing the at least one greeting message includes delaying the playing of the greeting message for a set period of time.

5. The method of claim 1, wherein associating includes remotely creating the association of messages to at least one of a time of day and a day of week or both and thereafter downloading the created association to the memory of the greeter.

6. The method of claim 5, wherein creating the association includes parting at least one of a day and a week or both into a plurality of parts and assigning messages to each of the plurality of parts.

7. The method of claim 1, comprising overriding the playing the at least one greeting message and the playing a different message when an override signal is input at a base station and communicated to the greeter.

8. The method of claim 1, wherein storing includes recording a message at the greeter and downloading a new content file, including at least one of a new message, new parting, or new message schedule, from a remote location.

9. A restaurant greeter system, comprising:
a customer interaction device remote from business personnel;
a customer presence detection system;
a greeter connected to the customer interaction device and the customer presence detection system, the greeter to play a greeting message upon automatically detecting presence of a customer by the customer presence detection system, the greeter receiving a content file, which was created remotely, that includes messages and a play schedule of when an individual message can be played, the greeter storing messages that are temporally assigned for the greeter to play at the customer interaction device and the schedule; and
a base station connected to the greeter and to electrically communicate with the greeter, the customer presence detection system, and the customer interaction device.

10. The restaurant greeter system of claim 9, comprising a bypass connection joining the base station to the greeter in a first mode and joining the base station directly to the customer interaction device and the customer detection system in a second mode with the base station unconnected to the greeter.

11. The restaurant greeter system of claim 10, wherein the bypass connection includes an RJ31X circuit block.

12. The restaurant greeter system of claim 11, wherein the greeter includes a scheduling module that can assign play time for any individual message and override the schedule downloaded from the remote server.

13. The restaurant greeter system of claim 11, wherein the greeter includes a unique identifier so that it downloads only content files including messages and schedules, from the server, that are assigned to it.

14. The restaurant greeter system of claim 11, wherein the greeter includes a global communication module to connect to the server.

15. The restaurant greeter system of claim 11, wherein the greeter includes a module to stop playing a message when a signal is sensed from the base station intended for the customer interaction device.

16. The restaurant greeter system of claim 11, wherein the greeter includes a delay module that delays playing the message assigned to the day part.

17. The restaurant greeter system of claim 11, wherein the greeter includes an automated module that automatically connects to the remote server periodically to request updates.

18. A greeter scheduling device, comprising:
a memory;
a processor operatively coupled to the memory;
a builder module that is to create a content file including messages and a schedule that assigns messages to a time period for play by a remote greeter; and
an input/output device to download the content file to a greeter.

19. The greeter scheduling device of claim 18, wherein the building module includes a recording module to record messages to store in memory and to be used by the builder module to create the content file for use by at least one greeter.

20. The greeter scheduling device of claim 19, comprising a security module to protect the content file from unauthorized access.
